(19) United States
(12) Patent Application Publication
(10) Pub. No.: US 2020/0193392 A1
(43) Pub. Date: Jun. 18, 2020

(54) Apparatus And Method For Repair Of Industrial Machines

(71) Applicant: General Electric Company, Schenectady, NY (US)

(72) Inventors: Steven Lewis Curd, San Ramon, CA (US); Vijay John, Evendale, OH (US); Mikhail Krivenko, San Ramon, CA (US); Kris Hanna, Portadown (IE)

(21) Appl. No.: 16/224,138

(22) Filed: Dec. 18, 2018

(51) Int. Cl. G06Q 10/00; B23P 6/00; B64F 5/40; G05B 19/4097; G05B 19/408

(52) U.S. Cl. CPC G06Q 10/20; B23P 6/002; B64F 5/40; G05B 2219/50214; G05B 19/408; B23P 2700/01; G05B 19/4097

(57) ABSTRACT

An initial customized electronic work scope is created for an individual industrial asset. The initial electronic work scope is created according to the set of rules defined in the tree-like data structure and uses the determined condition of the asset. The initial customized electronic work scope is not necessarily the same as other work scopes of other industrial assets the same asset type. The initial customized electronic work scope defines an ordered sequence for removing a plurality of individual mechanical parts of the individual asset.

### BACKGROUND OF THE INVENTION

### Field of the Invention

The subject matter disclosed herein generally relates to repairing assets and, more specifically, to the repair paths followed through these assets.

### Brief Description of the Related Art

Various types of industrial assets exist. For example, aircraft engines, industrial machinery, motors, turbines, energy generation equipment, and manufacturing equipment exist and are used in different situations. These assets are sometimes serviced so that they can continue to operate properly. In other situations, the asset becomes inoperative or does not operate properly requiring repairs to be made to the asset.

Assets are typically constructed of various parts that are interconnected. Sometimes a part that needs to be repaired or replaced, and this target part is physically disposed beneath, behind, or embedded within or behind other parts. In these situations, the other parts have to be first removed to obtain access to the target part. In some situations, more than one path (sequence of part removals) exist to access the target part.

Various assets of the same type (e.g., aircraft engines) may be repaired at different facilities and/or with different teams of workers. These different facilities and/or workers develop their repair or servicing process on their own resulting in disparate procedures being followed. For example, these different facilities may use different paths to accesses the same target part of assets of the same type. This leads to inefficiency in repairing and servicing assets, which in turn increases costs.

### BRIEF DESCRIPTION OF THE INVENTION

The present invention is directed to approaches that prepare work scopes (e.g., ordered instructions that allow for the sequential disassembly of an asset) such as an aircraft engine. The instructions so created may be electronic and control the operation of robots at a repair facility, or they may be written to be read an executed by workers at the repair facility. Regardless, feedback may be provided from the repair facility and the work scopes improved and fine-tuned so that the end result is that the asset is repaired or serviced correctly to place the asset in operative condition.

In many of these embodiments, an industrial asset is repaired or serviced at a repair facility. An image of an asset that is entering a repair facility is obtained, and the image is analyzed to determine a condition of the asset.

A tree-like data structure is stored in a database. The tree-like data structure defines a set of rules that define parent-child mechanical placement relationships between individual mechanical parts that have been assembled to form a type of industrial asset. Selected ones of the mechanical parts have associated with them acceptable repair actions that can be performed on the part.

At an electronic interface and using a cloud-based application, an initial customized electronic work scope is created for an individual industrial asset of the type of industrial entering a repair facility for repair or servicing. The initial electronic work scope is created according to the set of rules defined in the tree-like data structure and uses the determined condition of the asset. The initial customized electronic work scope is not necessarily the same as other work scopes of other industrial assets the same asset type. The initial customized electronic work scope defines an ordered sequence for removing a plurality of individual mechanical parts of the individual asset.

The initial customized electronic work scope is transmitted to a technician or a robot that are disposed at the repair facility. The technician or robot utilizes the initial customized work scope to perform at least an initial examination of the asset.

In aspects, after receiving the asset in the repair facility, the asset is disassembled and then subsequently inspected. One or more of the disassembling and inspecting are performed at least in part by the robot. The initial customized electronic work scope is adjusted to form a final customized electronic work scope. The final customized electronic work scope when performed by the human or the robot is effective to cause the asset to be successfully repaired. The final customized electronic work scope defines an optimum disassembly path and sequence for disassembling the parts of the asset.

In examples, the asset type is an aircraft engine. Other types of assets are possible.

In other examples, a replacement part is automatically ordered and inspected at the repair facility. In other aspects, the initial customized electronic work scope comprises or causes the creation of electronic control signals that control operation of the robot.

In still other examples, the data structure is changed based upon results or information obtained by disassembling the asset and then subsequently inspecting the disassembled asset.

In yet other examples, the acceptable repair actions include repairing the part or replacing the part. These actions, in aspects, can be carried out by a robot.

In other aspects, the rules defined by the tree-like data structure include consideration of where the individual asset was used, how long the individual asset was used, and how many new parts are included the individual asset.

In yet other aspects, the work scope is adjusted based at least in part upon feedback received from the technician or robot.

In others of these embodiments, a system for repairing an industrial asset at a repair facility includes a camera, a data base, a cloud-based application, and a robot. The camera is configured to obtain an image of an asset that is entering a repair facility. The image is analyzed to determine a condition of the asset.

The database is configured to store a tree-like data structure. The tree-like data structure defines a set of rules that define parent-child mechanical placement relationships as between individual mechanical parts that have been assembled to form a type of industrial asset. Selected ones of the mechanical parts have associated with them acceptable repair actions that can be performed on the part.

The cloud-based application is utilized at a first electronic interface to create an initial customized electronic work scope for an individual industrial asset of the asset type entering a repair facility for repairs according to the set of rules and the determined condition of the asset. The initial customized electronic work scope is not necessarily the same as other work scopes of other industrial assets the same asset type. The initial customized electronic work scope defines an ordered sequence for removing a plurality of individual mechanical parts of the individual asset;

The robot disposed at the repair facility. The application is configured to transmit the initial customized electronic work scope from the first electronic interface to a second electronic interface disposed at the repair facility via an electronic communication network. The second electronic interface is associated with a technician at the repair facility or the robot. The technician or robot utilizes the initial customized work scope to perform at least an initial examination of the asset.

In aspects, after receiving the asset in the repair facility, the asset is disassembled and then subsequently inspected at least in part by the robot according to the initial customized electronic work scope. The initial customized electronic work scope is adjusted by the application at the first interface to form a final customized electronic work scope. The final customized electronic work scope when performed by the human or the robot is effective to cause the asset to be repaired, the final customized electronic work scope defining an optimum disassembly path and sequence for disassembling the parts of the asset.

### BRIEF DESCRIPTION OF THE DRAWINGS

For a more complete understanding of the disclosure, reference should be made to the following detailed description and accompanying drawings wherein:

FIG. 1 comprises a diagram of a system according to various embodiments of the present invention;

FIG. 2 comprises a flowchart of a approach according to various embodiments of the present invention;

FIG. 3 comprises a diagram of aspects of a system according to various embodiments of the present invention;

FIG. 4 comprises a diagram of aspects of a system according to various embodiments of the present invention;

FIG. 5 comprises a diagram of aspects of a system according to various embodiments of the present invention;

FIGS. 6A, 6B, and 6C comprise diagrams of aspects of a system according to various embodiments of the present invention;

FIGS. 7A, 7B, and 7C comprise a diagram of aspects of a system according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the present approaches, work scopes (e.g., ordered instructions that allow for or direct the sequential disassembly of an asset into the assets constitute parts or components) are prepared using an electronic computer application (e.g., an application that resides and is executed at the cloud). The work scopes specify one or more disassembly paths for components of an asset such as an aircraft engine. Rules are enforced in creating the work scopes to enforce standardization, efficiency, and correctness in the disassembly paths (e.g., the ordered sequence of how components are to be removed).

In one example, when an aircraft engine arrives at a repair or servicing facility (“shop”), there are many decisions that need to be made about the scope of the work required and how to accomplish that work in as little time as possible with as little cost. The approaches provided herein allow an organization to define a repeatable process based on best practices that can be enforced across geographically disperse teams. During the repair process, each module or component of an asset that is disassembled increases the cost of the shop visit along with the time needed for that shop visit. By using the present approaches, the person or robot assigned to create and/or execute a work scope for that shop visit can be guaranteed that they are using the most efficient process for exposing the components of the engine that require repair during that shop visit.

Since the approaches are dynamically structured, the approaches can be used across different engine families and potentially across any type of repair. Aircraft engine repair is one example for the use of the present approaches since the cost of disassembling an aircraft engine exponentially more expensive than similar products such as automobile engines. Additionally, as a dynamic structure, the approaches provided herein allow for discovery of new disassembly paths and can be easily shared across multiple teams of workers or robots.

As mentioned, the approaches are advantageously deployed in the repair and servicing of aircraft engines. Most aircraft engines have a minimum 30 year lifespan, and the flexible structures described herein allow for adding additional modules, and specifying composite removals and disassembly types as the aircraft engineers continue to evolve the design of the engine over its lifespan. The present approaches also allow for ease of maintenance of the dynamic module structures for an engine, and allow for workers or robots to be guided down the path of least expense and least complexity when performing an engine repair or an engine upgrade.

In examples, the approaches provided herein include a web application (or tool) and multiple microservices that are deployed into a platform such as the Predix platform (manufactured and provided by the General Electric Company). The application has two main components: an administration component and a work scope creation component. The administrative component is used to create and maintain the module lists and disassembly structures for each engine (or other asset type) model. The work scope creation component uses these structures once a user has selected an engine (or other asset) he/she will be working. Once an engine (or other asset) is selected, the application can look up the corresponding engine (or other asset) model and load the appropriate template for that engine (or other asset) family.

Advantageously, the approaches provided herein determine the shortest path to a given engine (or other asset) component; standardize disassembly and removal procedures across multiple locations, teams, and vendors; and identify additional work for a given module once that module has been selected for disassembly or removal. For the shortest path problem, the tool presents the user (or robot) with multiple options for getting to a specific module or part that is slated for repair. Once the module with that part is determined, a user can test different paths to determine which gets to the part quickest while also ensuring that additional modules being serviced during that shop visit are included in the path.

For the standardization problem, the approaches described herein provide a centralized source of repair paths and previous completed/approved workflows. There is no longer a need for a manual process to obtain the latest information or to get physical copies of previous work scopes since all that data is not available via this tool. Finally, to help locate additional work, once a user (or robot) has set the disassembly or removal path for an engine (or other asset), they can also view any service bulletins that are associated to modules on the path that have not already been addressed by prior shop visits.

The present approaches are superior to previous paper-based systems since the approaches described herein ease the decision-making process for the user. The latest version of the “best practices” for a work scope are always available.

Another advantage of this system is that it is a single source of truth regarding repair paths through an asset. Yet another advantage of having this tool in a cloud-hosted, web-based environment is that everyone using the system is using the exact same version of the work scope. In other words, standardization is achieved across different teams of workers and across different facilities.

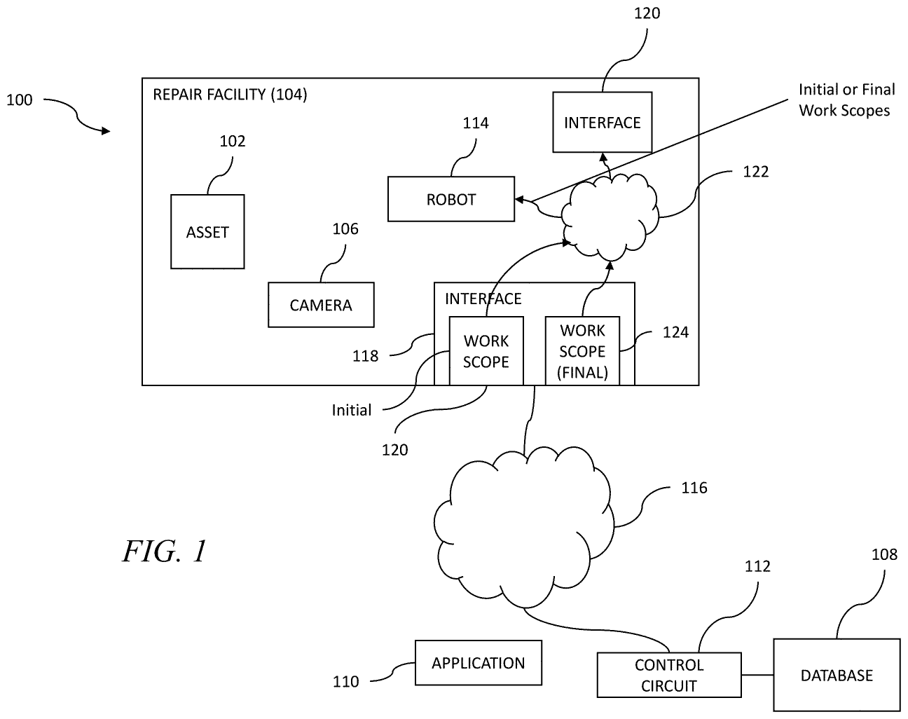

Referring now to FIG. 1, a system 100 for repairing an industrial asset 102 at a repair facility 104 includes a camera 106, a data base 108, a cloud-based application 110 (executed at a control circuit 112), and a robot 114.

The industrial asset 102 is any type of industrial asset (or asset generally even if not used in an industrial or commercial setting). In examples, the industrial asset may be an aircraft engine, any windmill component, a vehicle, industrial manufacturing equipment, boilers, furnaces, smelters, milling machines, or cutting machines to mention a few examples. Other examples are possible.

The repair facility 104 is any facility that repairs and/or services industrial assets. The facility (also referred to a shop, shop floor herein) is a physical location and may be a building, or a plurality of buildings. Repair or service personnel work in the facility 104. The repair facility 104 may have storage area for parts, and be connected to the cloud 116.

The camera 106 is configured to obtain an image of an asset that is entering a repair facility. The image is analyzed to determine a condition of the asset. The camera 106 may be any kind of sensor such as a sensor that obtains visual images or images in any other wave length of light. In addition, the camera may be a sensor such as a barcode scanner, or any scanner that scans any type of identifier (e.g., an RFID). Other examples of sensors and cameras are possible.

The database 108 is configured to store a tree-like data structure. The tree-like data structure defines a set of rules that define parent-child mechanical placement relationships as between individual mechanical parts that have been assembled to form a type of industrial asset. Selected ones of the mechanical parts have associated with them acceptable repair actions that can be performed on the part. The data base 108 may be disposed at the cloud 116.

The cloud-based application 110 is deployed at the cloud 116 and is utilized at a first electronic interface 118 to create an initial customized electronic work scope 120 for an individual industrial asset of the asset type entering a repair facility for repairs according to the set of rules and the determined condition of the asset. The initial customized electronic work scope is not necessarily the same as other work scopes of other industrial assets the same asset type. The initial customized electronic work scope defines an ordered sequence for removing a plurality of individual mechanical parts of the individual asset. The application 110 may be implemented as a software computer program.

The cloud 116 is any kind of network or combination of electronic communication networks. For example, the cloud may include or be accessed by networks such as the internet, cellular networks, wireless networks, wide area networks, or local area networks. Other examples and combinations are possible. The cloud 116 may be seen as a central processing location that is accessible from multiple repair facilities. Consequently, although not shown in FIG. 1, it will be understood that additional repair facilities and engineers may be coupled to the cloud 116 and perform the processes and functions and approaches that are described herein. This architecture allows efficiency and cost savings to be achieved since one version of the application 110 is running at a single, central location. If the application 110 changes, it can be modified at the central location. This architecture enforces a uniform approach across multiple repair facilities and would be difficult or impossible to achieve with a decentralized architecture.

The first electronic interface 118 is any type of user electronic device that includes a screen or display (e.g., a touchscreen or simply a display screen). The screen or display may also be associated with a keypad. In examples, the first electronic interface 118 is or is incorporated with a smartphone, a cellular phone, a laptop, a tablet, or a personal computer. Other examples are possible.

The robot 114 is disposed at the repair facility 104 and can be an aerial drone, an automated ground vehicle, or a fixed-in-location apparatus. The application 110 is configured to transmit the initial customized electronic work scope from the first electronic interface to a second electronic interface 120 disposed at the repair facility via an electronic communication network 122 or via the cloud 116. The electronic communication network 122 may be the internet, cellular networks, wireless networks, wide area networks, or local area networks. Other examples and combinations are possible. In examples, the second electronic interface 120 is associated with a technician at the repair facility or the robot. The technician or robot 114 utilizes the initial customized work scope to perform at least an initial examination of the asset.

The robot 114 may include arms, levers, gripping devices, tools, or sensors that when actuated perform functions on the asset 102. For example, the robot may remove asset components, probe the asset, or obtain images of the asset. The robot 114 may include a control circuit that executes electronic instructions or computer code that performs these instructions. The robot 114 also includes electronic communication interfaces allowing it to communicate with the cloud.

In one example, of the operation of the system of FIG. 1, the asset 102 is received at the repair facility 104. For instance, an engine may be brought into the repair facility. The camera 106 obtains images (or an engineer visually examines the asset) to determine a starting point for the repair or servicing. In examples, the electronic images are processed and analyzed automatically to determine problematic areas of the asset to suggest (automatically or manually) components of the asset 102 to examine or whether the entire asset is to be disassembled. Condition cues such as physical damage to the asset 102 may be determined in this process.

Using the application 110, the engineer creates the initial customized electronic work scope 120 for the industrial asset 102 of the asset type (e.g., aircraft engine) entering a repair facility for repairs according to the set of rules and the determined condition of the asset 102. As mentioned, the initial customized electronic work scope 120 is not necessarily the same as other work scopes of other industrial assets the same asset type (e.g., aircraft engine). The initial customized electronic work scope 120 defines an ordered sequence for removing a plurality of individual mechanical parts of the individual asset. The application 110 resides at a server (or servers) at the cloud 116 and is therefore not downloaded to the facility. In other words, the electronic interface 118 allows the engineer to enter data that is transmitted to be processed by the application at the cloud 116, or receives resultant data or information from the application 110 being executed by the control circuit 112 at the cloud 116. The initial customized work scope 120 is sent to the technicians and/or robots 114 in the repair facility.

In sending the initial customized electronic work scope 120, several actions may occur. The initial customized electronic work scope 120 may be converted into electronic instructions that are received by the robots 114 in the repair facility. Once received by the robots 114, the instructions are executed by the robots 114 to perform actions at the repair facility 104. For example, the robots 114 may be instructed to disassemble the asset 102 in a particular order (sequence) of components. In other examples, the robots 114 may be used to probe the asset 102. In still other examples, the robots 114 disassemble removed components of the asset 102. In yet other examples, the robots 114 include sensors that obtain images of components of the asset, the external surfaces of the asset 102, or internal spaces or components of the asset 102 to mention a few examples. An electronic conversion process (e.g., deployed at the cloud 116 or at the repair facility 104) takes actions (e.g., remove component X) and converts these to electronic instructions that are excitable by the robots 114. In aspects, the robots 114 include control circuits, which receive and execute the electronic instructions. In yet other examples, electronic computer code may be downloaded to the robot 114 to execute various one of the actions specified in the initial work scope 120.

The completed work scope is sent to another area of the repair facility 104 and more specifically to a second electronic interface 120 at this other area of the repair facility 104. In these regards, it will be understood that the repair facility 104 has separate areas for receiving assets, and other areas where the assets are repaired. The second electronic interface 120 may in one example be a communication interface at the robot 114. Alternatively, or in addition, the second electronic interface 120 may be any user electronic device that includes a screen or display (e.g., a touchscreen or simply a display screen). The screen or display may also be associated with a keypad. In examples, the second electronic interface 120 is or is incorporated with a smartphone, a cellular phone, a laptop, a tablet, or a personal computer. Other examples are possible.

After receiving the asset 102 in the repair facility, the asset 102 is disassembled and then subsequently inspected at least in part by the robot 114 according to the initial customized electronic work scope 120. The initial customized electronic work scope 120 is adjusted by the application at the first interface 118 to form a final customized electronic work scope 124. The final customized electronic work scope 124 when performed by the human or the robot is effective to cause the asset to be repaired. The final customized electronic work scope 124 defines an optimum disassembly path and sequence for disassembling the parts of the asset 102.

As mentioned, the control circuit 112 (disposed at the cloud) executes the application 110. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 112 may be configured (for example, by using corresponding programming stored in a memory as will be well understood by those skilled in the art) to carry out one or more of the steps, actions, and/or functions described herein.

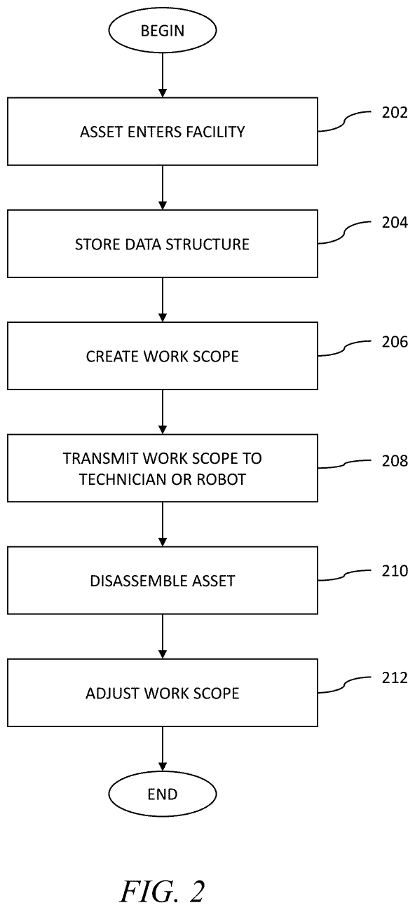

Referring now to FIG. 2, an approach for repairing or servicing an industrial asset at a repair facility is described. At step 202, the asset enters the repair facility and an image (or other information concerning the condition and/or identity) of the asset is obtained. The image is analyzed to determine the condition and/or identity of the asset.

At step 204, a tree-like data structure is stored in a database. The tree-like data structure defines a set of rules that define parent-child mechanical placement relationships between individual mechanical parts that have been assembled to form a type of industrial asset. Selected ones of the mechanical parts have associated with them acceptable repair actions that can be performed on the part.

At step 206 and at an electronic interface and using a cloud-based application, an initial customized electronic work scope is created for an individual industrial asset of the type of industrial entering a repair facility for repair or servicing. The initial electronic work scope is created according to the set of rules defined in the tree-like data structure and uses the determined condition of the asset. For example, the condition of the asset may determine which components of the asset are to be examined or removed, or whether the asset should be subjected to a complete overhaul (e.g., all or most parts disassembled or removed). The initial customized electronic work scope is not necessarily the same as other work scopes of other industrial assets the same asset type. In other words, each work scope is potentially unique and is customized to fit the condition of a specific example of the particular asset being repaired or serviced. The initial customized electronic work scope defines an ordered sequence for removing a plurality of individual mechanical parts of the individual asset. The initial work scope may be created using an application that is accessed from the cloud by an engineer that is remote from the cloud. The engineer may be located at the repair facility or may be located at some other remote location.

At step 208, the initial customized electronic work scope is transmitted to a technician or a robot that are disposed at the repair facility. Transmission may occur through the cloud or through some other dedicated electronic communication network. The technician or robot utilizes the initial customized work scope to perform at least an initial examination of the asset.

At step 210, after receiving the asset in the repair facility, the asset is disassembled and then subsequently inspected. One or more of the disassembling and inspecting are performed at least in part by the robot. For example, the robot may physically remove components, disassemble components or sub-components, obtain images. The robot may also include intelligence that allows it to independently perform some functions such as probing through the interior of the asset.

At step 212, the initial customized electronic work scope is adjusted to form a final customized electronic work scope. The final customized electronic work scope when performed by the human or the robot is effective to cause the asset to be successfully repaired. The final customized electronic work scope defines an optimum disassembly path and sequence for disassembling the parts of the asset. This step may involve various exchanges with the engineer creating the work scope. For example, the technicians may notice an issue with the asset and/or work scope and communicate this back to the engineer. The engineer may change the work scope as a result. The new work scope is then tested, resulting in further suggestions, comments, or observations that are communicated back to the engineer that further modifies the workshop. this back-and-forth process continues until the work scope is used to correctly solve the problem/repair the asset.

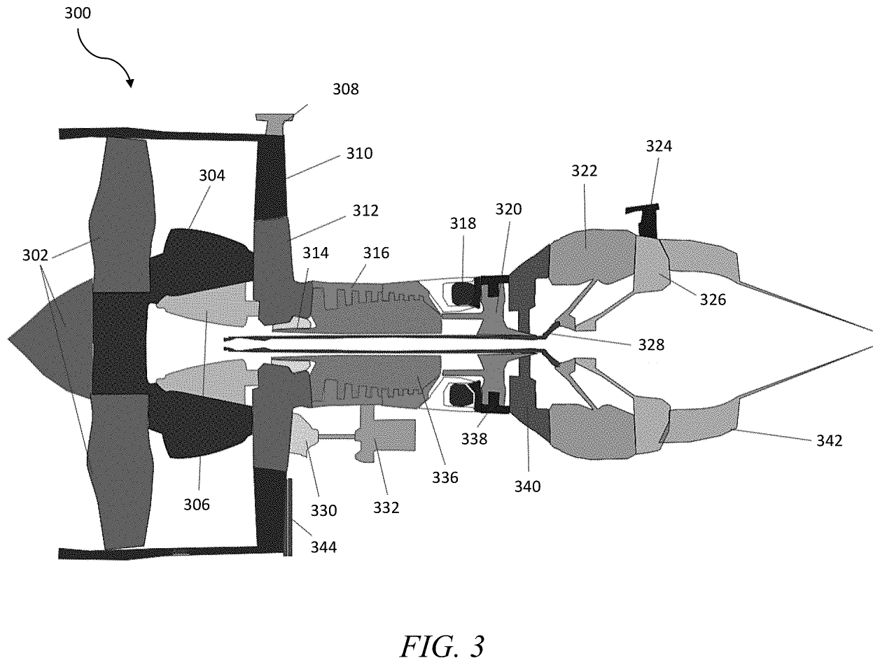

Referring now to FIGS. 3-7, one example of how the approaches described herein can be implemented is provided. It will be appreciated that these are one example and rely on the asset being an aircraft engine. But, it will be appreciated that these are examples only and that different screens, data structures, and asset types can be used. In these examples, an engineer interfaces with a web-based application through a web-based interface. The engineer may be located at the repair facility or at some other location remote from the cloud.

FIG. 3 shows a cross section of an asset, in this case, an aircraft engine. The asset 300 includes rotating hardware 302, a booster 304, a bearing 306, a forward mount 308, a fan case 310, a fan hub frame 312, a gear box 314, a compressor stator 316, a combustor 318, a rotor 320, a second rotor 322, a mount 324, a turbine rear frame 326, a fan mid shaft 328, TGB 330, AGB 332, compressor rotor assembly 336, nozzle assembly 338, turbine center frame 340, exhaust 342, and lower bifurcation 344. Other parts may also be included and the operation of these parts is not described here. However, it can be seen that the parts when assembled form the asset. It can also be seen that some parts must be removed before other parts can be accessed. For example, the compressor rotor assembly 336 is buried deep in the asset 300 requiring various other parts to be removed to access the assembly 336. It can also be appreciated that parts need to be removed in a particular order to reach a component. It will additionally be appreciated that this is one example of an asset and that other components may exist within this particular example.

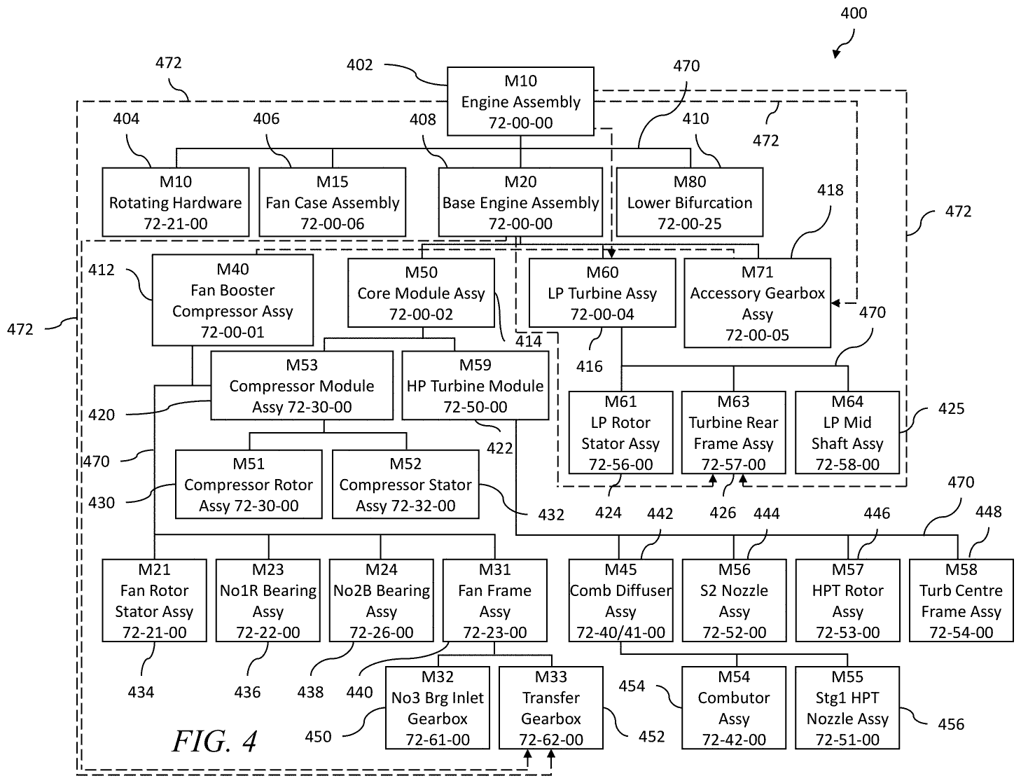

FIG. 4 shows a tree-like data structure 400. A root node 402 represents the overall engine assembly (e.g., engine assembly 300) and the various leaves 404-456 represent parts of the asset (e.g., the constitute parts of the asset 300). The branching structure defines parent/child/grand-child/great-grandchild/etc. relationships. Thus, the assembly 402 can be broken into rotating hardware 404, fan case assembly 406, base engine assembly 408, and lower bifurcation 410. The structure shows ordered sequenced disassembly paths through the engine assembly. In one example, a disassembly path would be disassemble or remove the base engine assembly, then the core module assembly, then the compressor module assembly, and then the compressor stator assembly. It will be appreciated that this is one example path and that various other example paths exist in the data structure 400

The branching structure of the tree defines a primary disassembly paths 470 (shown as solid lines) and secondary disassembly paths 472 (shown as dotted lines). The primary disassembly paths 470 are paths that may be given as defaults or may involve disassembling a large portion of the engine. The secondary disassembly paths 472 may be more directed or “surgical strike” paths that show how a particular asset component may be most quickly accessed (without following the general path).

The tree-like data structure 400 is a set of rules showing possible paths. As a user or automated process determines parts to remove, the tree-like data structure is used to enforce rules and standardized paths that can be used by technicians or robots at the facility to move the parts.

The tree-like data structure may be associated with a table (or similar data structure). Disassembly notes may be associated with particular components. As explained elsewhere herein, these notes may refer to disassembly notes/instructions associated with different levels of disassembly for a particular component. For instance, a first level (corresponding to visual inspection) may be associated with a particular component and a note attached to this component at that level may instruct a technician to visually inspect the component (or may be converted into electronic instructions causing a robot at the repair facility to obtain and analyze visual images of the component).

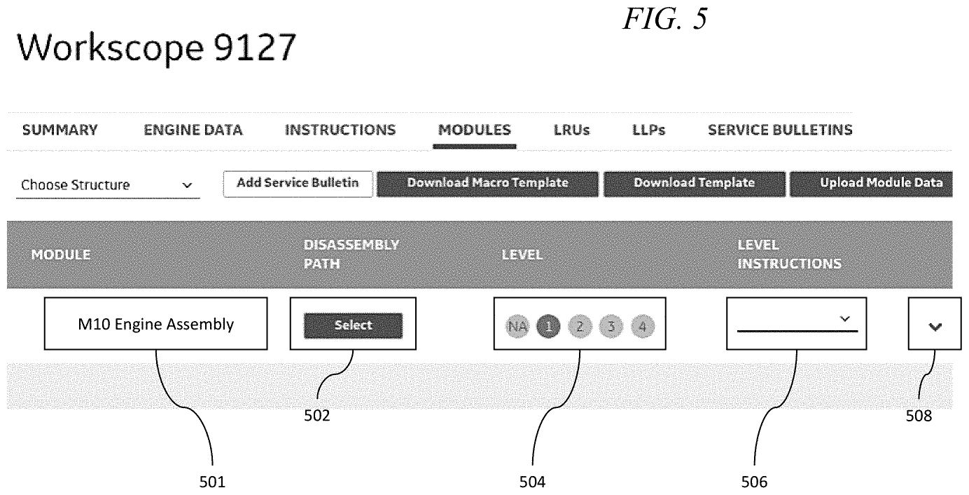

FIG. 5 shows a screen 500 presented to an engineer when executing the application. A particular asset module is shown on the screen having an asset name 501. If the engineer wishes to select a disassembly path involving the module, they hit a select button 502 to select this path. Levels 504 are mechanisms by which the user can select different disassembly options. This can range from visual inspection (level 1) to complete disassembly or complete overhaul (level 4, enhanced inspection, e.g., including x-ray analysis). Level selections will influence (or select) the level instructions that are applicable for the asset module. The instructions are a drop-down menu 506 where a user can select workshop instructions that are specific to a module. Expand/collapse button 508 allows a user to see or hide additional information about an asset module.

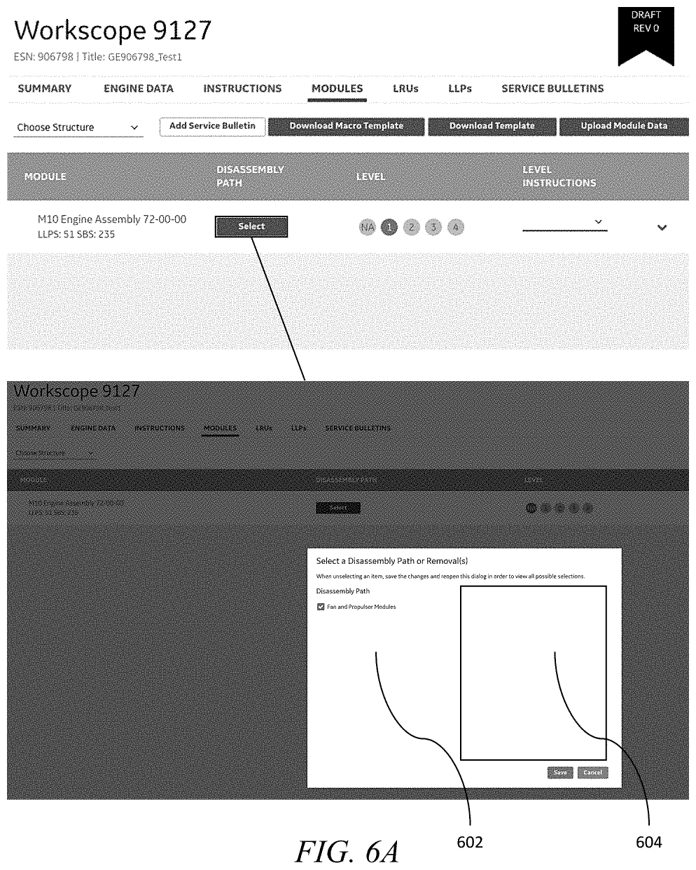

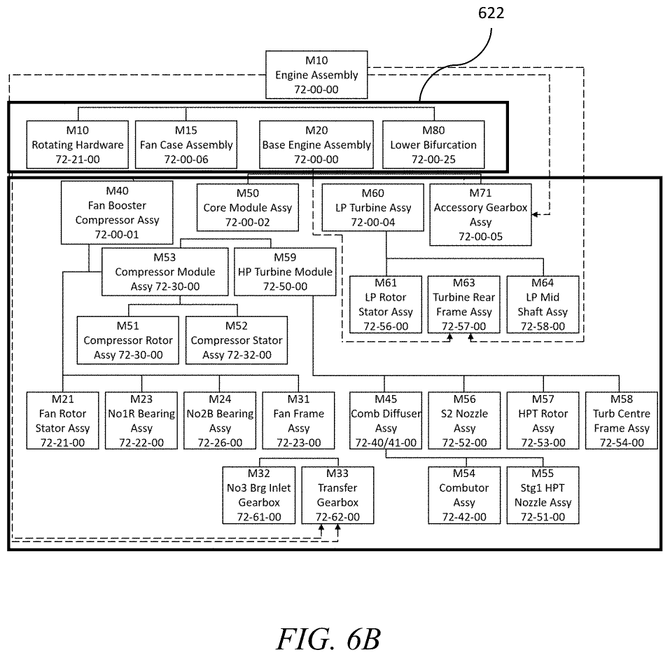

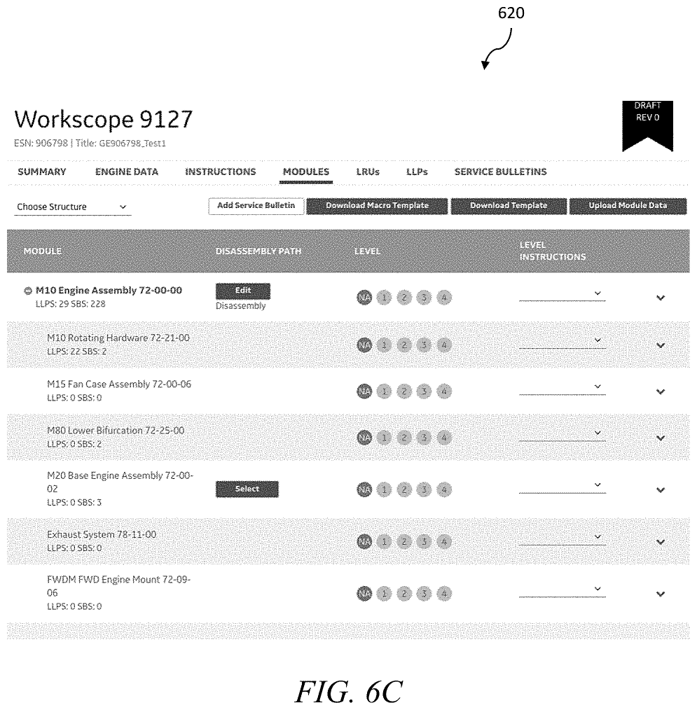

FIG. 6A shows a screen 600 created where the engineer (user) navigates to the modules tab and makes a selection. The selection causes a pop up screen 602 to be produced. A user can select either a primary or standard disassembly path 604, or individual modules 606 that are directly accessible. In this case the user selects the primary path 604. This produces a screen 620 shown in FIG. 6C showing modules that are part of the disassembly path. FIG. 6B shows the tree-like structure (showing FIG. 3) and the modules selected by the engineer as indicated by the upper rectangle 622. These relate to the listed modules shown on the screen 620 shown in FIG. 6C. The engineer (user) makes level instruction selections and/or adds comments to create the screen 620 shown in FIG. 6C.

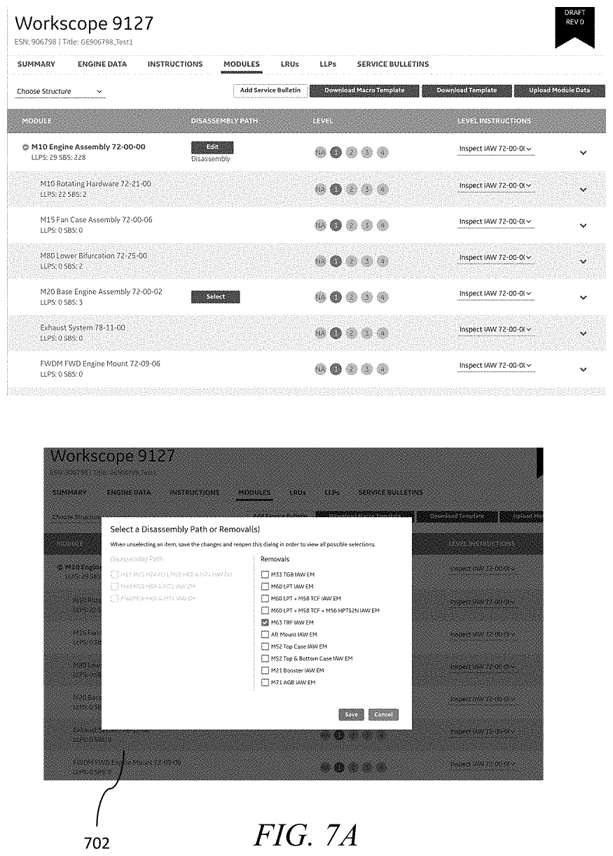

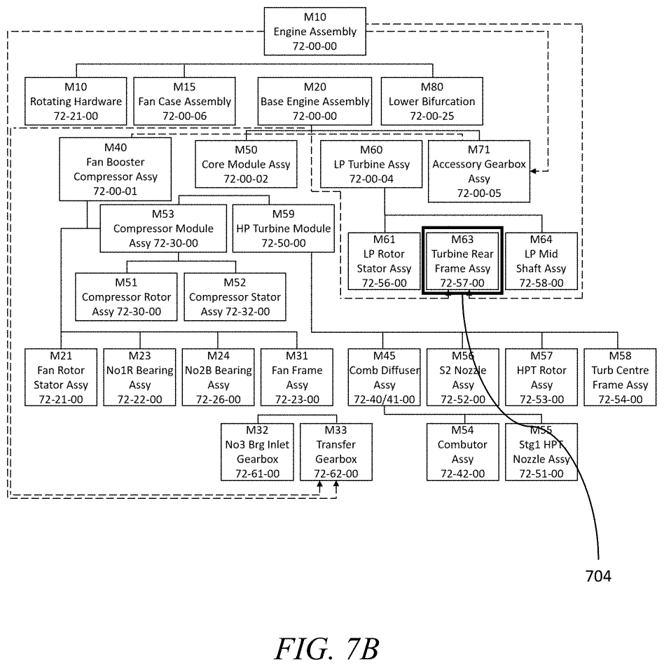

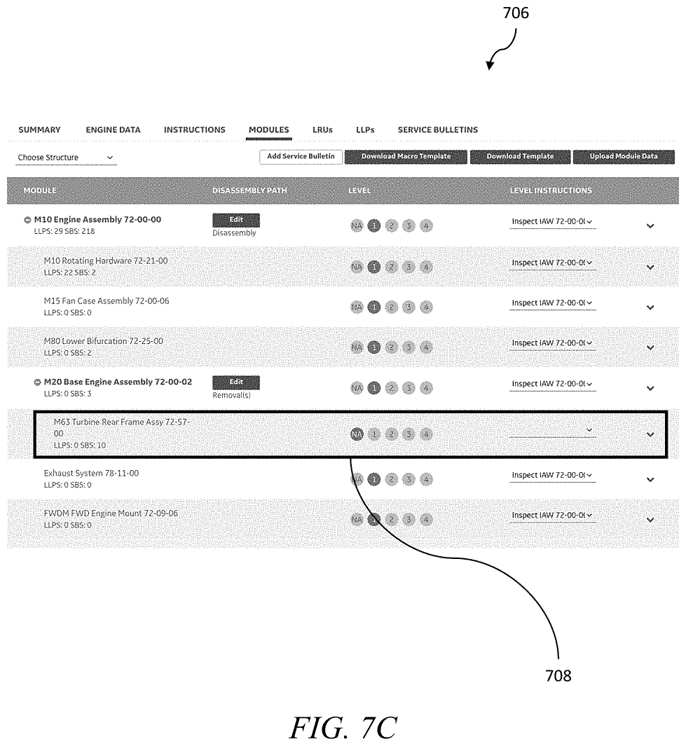

FIG. 7A shows a screen 700 where the engineer selects a particular component to remove and this selection is made in the pop-up screen 702. This component is shown in the tree diagram shown in FIG. 7B with the component identified with the identifier labeled 704. The engineer's selection causes creation of the screen 706 shown in FIG. 7C. In the screen 706, the engineer (user) can select a disassembly level 708 for the component. The engineer can add instructions or use already existing instructions.

As can be seen, the engineer progresses through the screens described above. The modules presented to the engineer and paths are regulated and controlled by the data structure of FIG. 4. The engineer (user) can also select a pre-determined disassembly path and level instructions. For example, a single button may be pressed on a screen to select the pre-determined path. Thus, the user does not have to go through multiple screens. The predetermined choices may be governed by a workshop administration function, which can be implemented as computer software. One click can be used to accomplish level and workshop instructions.

The end result of the above-mentioned process is to create initial instructions (work scope) for workers and/or robots in a repair facility. The initial instructions may be written and sent to the worker and the worker reads the instructions and disassembles according to the instructions. In addition, with respect to certain functions, or alternatively, the instructions created by these screens are converted into electronic instructions, which are executed by robots.

Once sent to the workshop, the disassembly (e.g., partial or complete) commences. There may be feedback from the robot or the human at the repair facility. This feedback may be returned in some form to the engineer or the process that creates the work scope. For example, actual examination may indicate a part cannot be safely removed or may indicate other actions or inspections are needed. The workshop can be altered based upon this and returned to the shop. This iterative process continues until the asset is satisfactorily repaired or serviced. The work scope can be saved so that future repairs will not require it to be relearned.

The work scope is finalized by the feedback. Once work is performed and the asset successfully completed, the work scope can be marked as being successfully completed. This may be needed to satisfy regulatory requirements of various government agencies in various jurisdictions.

It can be seen that the processes described are dynamic. Thus, knowledge can be shared and used to standardize disassembly processes. Knowledge gained as to what constitutes a successful disassembly is incorporated into a finalized work scope. These work scopes can be stored and analyzed at the cloud or at other suitable locations.

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method of repairing an industrial asset at a repair facility, the method comprising:
obtaining an image of an asset that is entering a repair facility, the image being analyzed to determine a condition of the asset;
storing a tree-like data structure in a database, the tree-like data structure defining a set of rules that define parent-child mechanical placement relationships between individual mechanical parts that have been assembled to form a type of industrial asset, selected ones of the mechanical parts having associated with them acceptable repair actions that can be performed on the part;
creating at an electronic interface and using a cloud-based application an initial customized electronic work scope for an individual industrial asset of the type of industrial entering a repair facility for repairs, the initial electronic work scope being created according to the set of rules defined in the tree-like data structure and using the determined condition of the asset, the initial customized electronic work scope not necessarily being the same as other work scopes of other industrial assets the same asset type, the initial customized electronic work scope defining an ordered sequence for removing a plurality of individual mechanical parts of the individual asset;
transmitting the initial customized electronic work scope to a technician or a robot that are disposed at the repair facility;
wherein the technician or robot utilizes the initial customized work scope to perform at least an initial examination of the asset.

2. The method of claim 1, further comprising:
after receiving the asset in the repair facility, disassembling the asset and then subsequently inspecting the disassembled asset, one or more of the disassembling and inspecting being performed at least in part by the robot;
adjusting the initial customized electronic work scope to form a final customized electronic work scope, the final customized electronic work scope when performed by the human or the robot being effective to cause the asset to be repaired, the final customized electronic work scope defining an optimum disassembly path and sequence for disassembling the parts of the asset.

3. The method of claim 1, wherein the asset type is an aircraft engine.

4. The method of claim 1, further comprising automatically ordering a replacement part and inspecting replacement part at the repair facility.

5. The method of claim 1, wherein the initial customized electronic work scope comprises or causes the creation of electronic control signals that control operation of the robot.

6. The method of claim 1, wherein the data structure is changed based upon results or information obtained by disassembling the asset and then subsequently inspecting the disassembled asset.

7. The method of claim 1, wherein the acceptable repair actions include repairing the part or replacing the part.

8. The method of claim 1, wherein the rules defined by the tree-like data structure include consideration of where the individual asset was used, how long the individual asset was used, and how many new parts are included the individual asset.

9. The method of claim 1, wherein adjusting the work scope is based at least in part upon feedback received from the technician or robot.

10. A system for repairing an industrial asset at a repair facility, the system comprising:
a camera for obtaining an image of an asset that is entering a repair facility, the image being analyzed to determine a condition of the asset;
a database that is configured to store a tree-like data structure, the tree-like data structure defining a set of rules that define parent-child mechanical placement relationships as between individual mechanical parts that have been assembled to form a type of industrial asset, selected ones of the mechanical parts having associated with them acceptable repair actions that can be performed on the part;
a cloud-based application utilized at a first electronic interface to create an initial customized electronic work scope for an individual industrial asset of the asset type entering a repair facility for repairs according to the set of rules and the determined condition of the asset, the initial customized electronic work scope not necessarily being the same as other work scopes of other industrial assets the same asset type, the initial customized electronic work scope defining an ordered sequence for removing a plurality of individual mechanical parts of the individual asset;
a robot disposed at the repair facility;
wherein the application is configured to transmit the initial customized electronic work scope from the first electronic interface to a second electronic interface disposed at the repair facility via an electronic communication network, the second electronic interface being associated with a technician at the repair facility or the robot;
wherein the technician or robot utilizes the initial customized work scope to perform at least an initial examination of the asset.

11. The system of claim 10,
wherein after receiving the asset in the repair facility, the asset is disassembled and then subsequently inspected at least in part by the robot according to the initial customized electronic work scope;
wherein the initial customized electronic work scope is adjusted by the application at the first interface to form a final customized electronic work scope, the final customized electronic work scope when performed by the human or the robot being effective to cause the asset to be repaired, the final customized electronic work scope defining an optimum disassembly path and sequence for disassembling the parts of the asset.

12. The system of claim 10, wherein the asset type is an aircraft engine.

13. The system of claim 10, wherein the second electronic interface is configured to order a replacement part and wherein the robot or the technician inspects the replacement part at the repair facility.

14. The system of claim 10, wherein the initial customized electronic work scope comprises or causes the creation of electronic control signals that control operation of the robot.

15. The system of claim 10, wherein the data structure is changed based upon results or information obtained by disassembling the asset and then subsequently inspecting the disassembled asset.

16. The system of claim 10, wherein the acceptable repair actions include repairing the part or replacing the part.

17. The system of claim 10, wherein the rules defined by the tree-like data structure include consideration of where the individual asset was used, how long the individual asset was used, and how many new parts are included the individual asset.

18. The system of claim 10, wherein the work scope is adjusted at the first electronic interface based at least in part upon feedback received from the technician or robot.
